(19) United States
(12) Patent Application Publication
(10) Pub. No.: US 2025/0135970 A1
(43) Pub. Date: May 1, 2025

(54) CHILD RESTRAINT

(71) Applicant: Dorel Juvenile Group, Inc., Foxboro, MA (US)

(72) Inventors: William P. MCHUGH, Norfolk, MA (US); Jason H. JOHNSON, Brownstown, IN (US); Grant M. MASON, Wrentham, MA (US)

(21) Appl. No.: 18/925,754

(22) Filed: Oct. 24, 2024

Related U.S. Application Data
(60) Provisional application No. 63/545,650, filed on Oct. 25, 2023.

(51) Int. Cl. B60N 2/28

(52) U.S. Cl. CPC B60N 2/2869

(57) ABSTRACT

A child restraint includes a seat base and a juvenile seat coupled to the seat base. The seat base may include a seat-base foundation adapted to rest on a vehicle seat and a seat-orientation controller coupled to the seat-base foundation for rotation about a vertical rotation axis. The juvenile seat may be configured to couple to the seat-orientation controller to be secured to the vehicle seat. The juvenile seat is rotatable relative to the seat base between a forward-facing orientation and a rearward-facing orientation relative to the seat-base foundation.

### PRIORITY CLAIM

This application claims priority under 35 U.S.C. § 119 (e) to U.S. Provisional Patent Application No. 63/545,650, filed Oct. 25, 2023, which is expressly incorporated by reference herein in its entirety.

### BACKGROUND

The present disclosure relates to a child safety device, and particularly to a child car seat. More particularly, the present disclosure relates to a child car seat with multiple modes of use.

### SUMMARY

According to the present disclosure, a child restraint includes a seat base and a juvenile seat coupled to the seat base. The seat base may include a seat-base foundation adapted to rest on a vehicle seat and a seat-orientation controller coupled to the seat-base foundation for rotation about a vertical rotation axis. The juvenile seat may be configured to couple to the seat-orientation controller to be secured to the vehicle seat. The juvenile seat is rotatable relative to the seat base between a forward-facing orientation and a rearward-facing orientation relative to the seat-base foundation.

In illustrative embodiments, the child restraint further includes an orientation indicator configured to change between a first appearance or configuration and a second appearance or configuration. In the first configuration, the orientation indicator indicates that the juvenile seat is in the forward-facing orientation or the rearward-facing orientation. In the second configuration, the orientation indicator indicates that the juvenile seat is not in the forward-facing orientation or the rearward-facing orientation.

In illustrative embodiments, the orientation indicator includes a pair of retractable protrusions and the seat-orientation controller includes a pair of fixed cams. When the juvenile seat is in the forward-facing orientation and the rearward-facing orientation, each cam engages a corresponding one of the pair of retractable protrusions to displace the pair of retractable protrusions so that the orientation indicator assumes the first configuration. When the juvenile seat is not in the forward-facing orientation and the rearward-facing orientation, each cam is spaced apart from the pair of retractable protrusions and the orientation indicator assumes the second configuration.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a child restraint, in accordance with the present disclosure, including a juvenile seat oriented in a sideways, installation orientation and a seat base configured to be coupled to the juvenile seat and located between the juvenile seat and an underlying vehicle seat to support the juvenile seat on the vehicle seat;

FIG. 2 is an enlarged view of a portion of the child restraint of FIG. 1 showing the child restraint further including an orientation indicator configured to indicate when the juvenile seat is in the sideways, installation orientation relative to at least a portion of the seat base;

FIG. 3 is a perspective view of the child restraint showing the juvenile seat in a travel orientation, including a forward-facing orientation and a rearward-facing orientation;

FIG. 4 is an enlarged view of a portion of the child restraint of FIG. 3 showing the orientation indicator indicating when the juvenile seat is in the travel orientation relative to at least a portion of the seat base;

FIG. 5 is a perspective and cross sectional view of the seat base showing the orientation indicator including an indicator panel and a panel actuator configured to move the indicator panel relative to the seat base in response to rotation of the juvenile seat relative to at least a portion of the seat base between the sideways, installation orientation and the travel orientation, and showing the panel actuator in an unactuated position to cause the indicator panel to provide a first visual representation through an opening formed in the seat base which indicates when the juvenile seat is not in the travel orientation;

FIG. 6 is a perspective and cross sectional view of the seat base showing the panel actuator in an actuated position to cause the indicator panel to provide a visual representation through the opening formed in the seat base which indicates when the juvenile seat is in the travel orientation;

FIG. 7 is an exploded assembly view of the seat base showing the seat base including a seat-base foundation and a seat orientation controller configured to couple with the seat-base foundation to allow rotation of the juvenile seat relative to the seat-base foundation about a vertical rotation axis between the sideways, installation orientation, the forward-facing position and the rearward-facing position;

FIG. 8 is an enlarged view of a portion of the seat-orientation controller in FIG. 7 showing the seat-orientation controller including an attachment post and a pair of actuator movers coupled to the attachment post to extend radially outward away from the attachment post relative to the vertical rotation axis;

FIG. 9 is an enlarged view of a portion of the seat-orientation controller in FIG. 7 showing the seat-base foundation formed to include a post-receiving space configured to receive the attachment post of the seat-orientation controller, and showing a portion of the panel actuators extending radially inward toward the vertical rotation axis to interact with the pair of actuator movers in response to rotation of the juvenile seat and the seat-orientation controller about the vertical rotation axis;

FIG. 10 is a top view of the seat base with portions of the seat orientation controller removed to show the pair of actuator movers engaged with a corresponding panel actuator included in the orientation indicator to cause a corresponding indicator panel to display the second visual representation on each side of the seat base when the juvenile seat is in the travel orientation;

FIG. 11 is a top view of the seat base with portions of the seat orientation controller removed to show the pair of actuator movers spaced from each corresponding panel actuator included in the orientation indicator to cause each corresponding indicator panel to display the first visual representation on each side of the seat base;

FIG. 12 is an exploded assembly view of the orientation indicator showing the panel actuator including a retractable protrusion configured to engage the pair of actuator movers, a pivot axle coupled to the indicator panel, and an actuator arm extending between and interconnecting the retractable protrusion and the pivot axle to transfer motion of the retractable protrusion to the pivot axle and into the indicator panel to cause the indicator to pivot relative to the seat base;

FIG. 13 is a perspective view of the panel actuator and indicator panel assembled with a housing formed to include a guide channel receiving the actuator arm of the panel actuator to guide non-linear movement of the actuator arm relative to the seat base in response to linear movement of the retractable protrusion;

FIG. 14 is another perspective view of the panel actuator and the indicator panel assembled in the housing; and

FIG. 15 is a perspective view of the panel actuator and the indicator panel showing the pivot axel spaced apart from an indicator panel pivot axis about which the indicator panel pivots in response to movement of the panel actuator.

### DETAILED DESCRIPTION

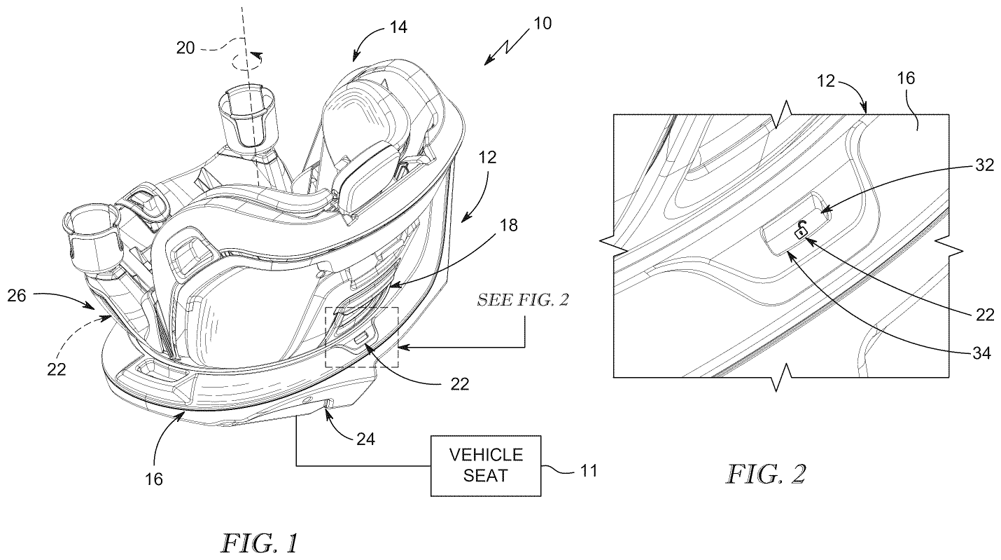

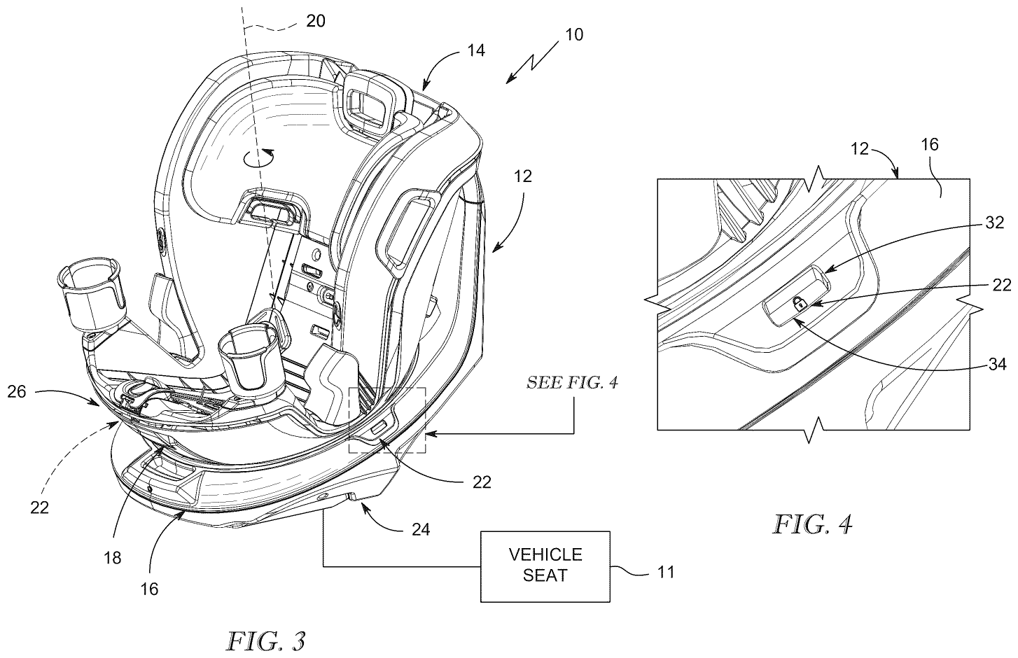

A child restraint 10 is adapted to rest on a vehicle seat 11 for transportation in a vehicle in a travel orientation, as shown in FIG. 2, and includes a seat base 12 and juvenile seat 14 that is rotatable to a sideways orientation, as shown in FIG. 1, for facilitated loading and unloading of a child from the juvenile seat 14. The seat base 12 includes a seat-base foundation 16 adapted to rest on the vehicle seat 11 and a seat-orientation controller 18 coupled to the seat-base foundation 16 for rotation about a vertical rotation axis 20. The juvenile seat 14 configured to couple to the seat-orientation controller 18 to be secured to the vehicle seat 11 by way of the seat base 12. The juvenile seat 14 is rotatable relative to the seat-base foundation 16 with the seat-orientation controller 18 between the travel orientation and the sideways orientation. Reference is hereby made to U.S. Provisional Application No. 63/419,505 filed Oct. 26, 2022 and entitled CHILD RESTRAINT for disclosure relating to use of a seat base, which application is hereby incorporated in its entirety herein.

In the illustrative embodiment, the travel orientation includes a forward-facing orientation and a rearward-facing orientation relative to the seat-base foundation 16 such that the juvenile seat 14 and the seat-orientation controller 18 are rotatable 360 degrees about the vertical rotation axis 20. In other embodiments, the juvenile seat 14 may only be rotatable between the forward-facing orientation and the sideways orientation or between the rearward-facing orientation and the sideways orientation.

In illustrative embodiments, the child restraint 10 further includes an orientation indicator 22 configured to change between a first appearance or configuration and a second appearance or configuration to indicate to users when the juvenile seat 14 is in the travel orientation and ready for transport in the vehicle. The first appearance of the orientation indicator 22 is displayed when the juvenile seat 14 is in the forward-facing orientation or the rearward-facing orientation. The second appearance of the orientation indicator 22 is displayed when the juvenile seat is not in the forward-facing orientation or the rearward-facing orientation. In some embodiments, the orientation indicator 22 displays the first appearance to indicate that the juvenile seat 14 is locked in the forward-facing orientation or the rearward-facing orientation and blocked from rotating about the vertical rotation axis 20 to indicate that the child restraint 10 is ready for transportation in the vehicle. In some embodiments, the orientation indicator 22 displays the second appearance to indicate that the juvenile seat 14 is not locked and may still be rotatable about the vertical rotation axis 20.

In some embodiments, the first and second configuration do not include a visual indication or appearance to indicate the state of the juvenile seat. In other words, the first and second configuration can cause a different tactile indication, such as an audible indication or a signal transmitted to one or more electrical components to provide a remote indication (i.e. an alert or message on a device, such as a mobile device or interface in a vehicle, or a vibration caused by a device in a vehicle seat or elsewhere in the vehicle). In some embodiments, the first and second appearances can be displayed in conjunction with one or more other tactile indications.

In the illustrative embodiment, the child restraint 10 includes an orientation indicator 22 on each lateral side 24, 26 of the seat base 12 so that the appearances are displayed in both lateral directions 24, 26 of the seat base 12 (and, hence, each lateral side of the vehicle). Only one orientation indicator 22 is shown and described in detail herein, although it should be noted that both orientation indicators 22 are substantially the same. In some embodiments, only one indicator 22, or a portion thereof, may, be included in the child restraint 10.

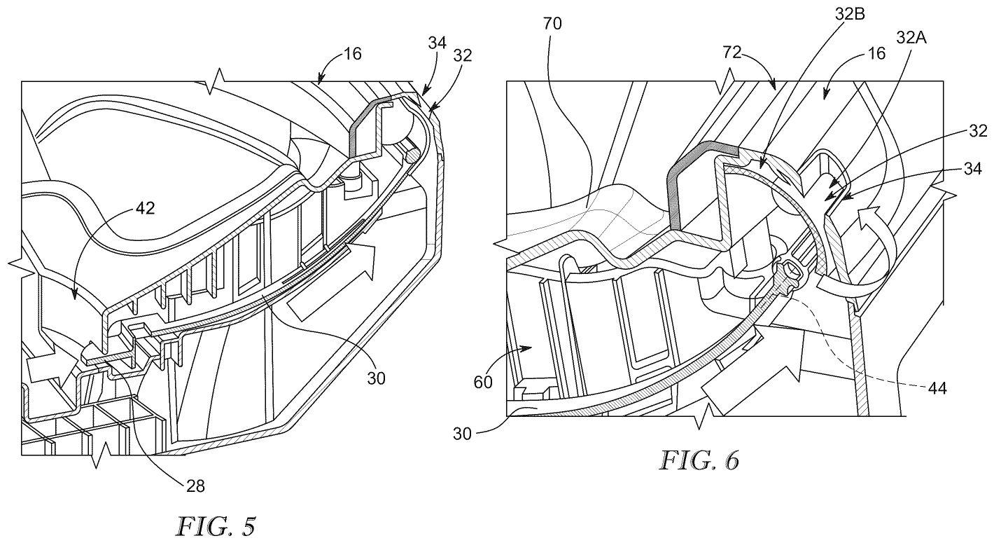

Each orientation indicator 22 includes an actuator having a movable protrusion 28 and an actuator arm 30 coupled to the movable protrusion 28 for movement therewith, and an indicator plate 32 configured to display the first and second appearances as shown in FIGS. 5 and 6. The movable protrusion 28 is configured to engage a portion of the seat base 12 in response to rotation of the juvenile seat 14 about the vertical rotation axis 20 from the sideways orientation to the travel orientation to cause the indicator plate 32 to display the first appearance when the juvenile seat 14 reaches the travel orientation. The actuator arm 30 interconnects the movable protrusion 28 and the indicator plate 32 to transfer movement of the movable protrusion 28 to the indicator plate 32. The indicator plate 32 is movable relative to the seat-base foundation 16 to display the first appearance of the indicator plate 32 or the second appearance of the indicator plate through a corresponding window 34 formed in the lateral sides 24, 26 of the seat-base foundation 16. The indicator plate 32 is spaced apart from the movable protrusion 28 to position the indicator plate 32 along one of the lateral sides 24, 26 of the seat-base foundation 16 so that the appearances displayed through the window 34 by the indicator plate 32 are easily seen by users from a doorway of the vehicle.

In the illustrative embodiment, the seat-orientation controller 18 includes an attachment body 36 configured to mount the juvenile seat 14 to the seat base 12, an attachment post 38 mounted to the seat-base foundation 16 to establish the vertical rotation axis 20, and one or more protrusion movers 40 (also called actuator movers) fixed to the attachment post 26. The attachment body 36 includes components that allow the juvenile seat 14 to attach to the seat-orientation controller 18 and to recline relative to the seat-base foundation 18, such as when the juvenile seat 14 moves from the rearward-facing orientation to the forward-facing orientation. The attachment post 38 extends downwardly from a lower end of the attachment body 36 and is sized to fit within a post-receiving space 42 formed in the seat-base foundation 16. Each of the protrusion movers 40 protrude outwardly from the attachment post 38 within the post-receiving space 42 to interact with the movable protrusions 28 of the orientation indicators 22 as the seat-orientation controller 18 and the juvenile seat 14 rotate about the vertical rotation axis 20.

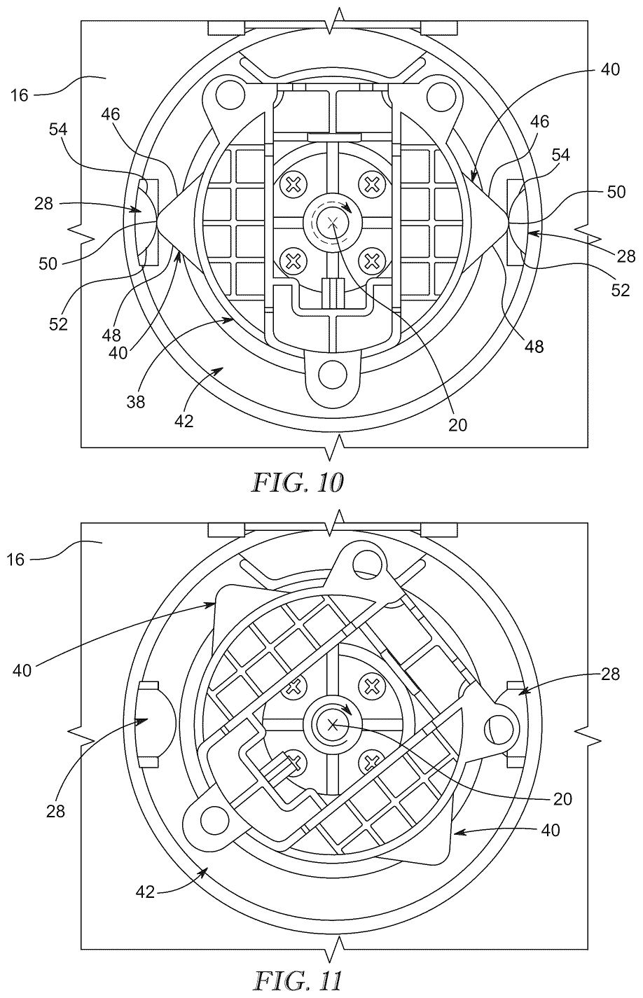

When the juvenile seat 14 is in the forward-facing orientation and the rearward-facing orientation, each protrusion mover 40 engages a corresponding movable protrusion 28 to displace the movable protrusion(s) so that the orientation indicator(s) 22 displays the first appearance as shown in FIG. 10. Each protrusion mover 40 includes a cam having sloped edges 46, 48 which converge at a point 50 to facilitate actuation of the movable protrusions 28 from either direction. Each movable protrusion may also include sloped edges 50, 52 or a rounded edge to facilitate actuation by the protrusion movers 40. When the juvenile seat 14 is not in the forward-facing orientation and the rearward-facing orientation, each protrusion mover 40 is spaced apart from the movable protrusion(s) 28 and the orientation indicator(s) 22 displays the second appearance as shown in FIG. 11. Each movable protrusion 28 is normally biased to extend toward the attachment post 38 and toward one another to normally display the second appearance.

The actuator arm 30 includes a flexible strip configured to translate lateral movement of each corresponding movable protrusion 28 into pivotable movement of each corresponding indicator plate 32 about a plate pivot axis 44 as suggested in FIG. 6. The indicator plate 32 is coupled to the seat-base foundation 16 for pivotable movement about the plate pivot axis 44 between a first position and a second position as suggested in FIG. 6. When the indicator plate 32 is in the first position, the protrusion movers 40 engage the movable protrusions 28 and a first portion 32A of the indicator plate 32 is visible through the window 34 formed in the seat-base foundation to display the first appearance. When the indicator plate 32 is in the second position, the protrusion movers 40 are spaced from the movable protrusions 28 and a second portion 32B of the indicator plate is visible through the opening formed in the seat-base foundation 16 to display the second appearance.

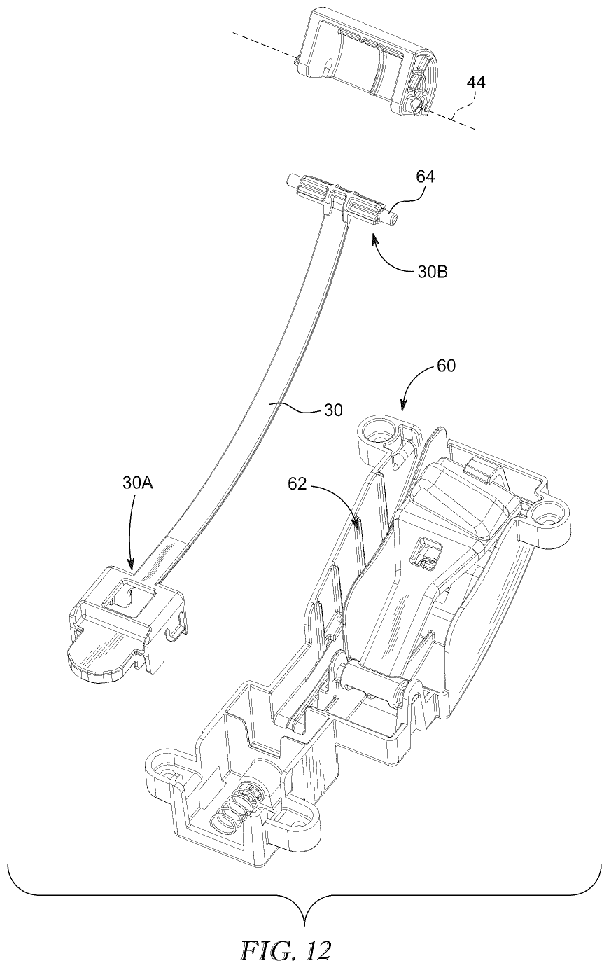

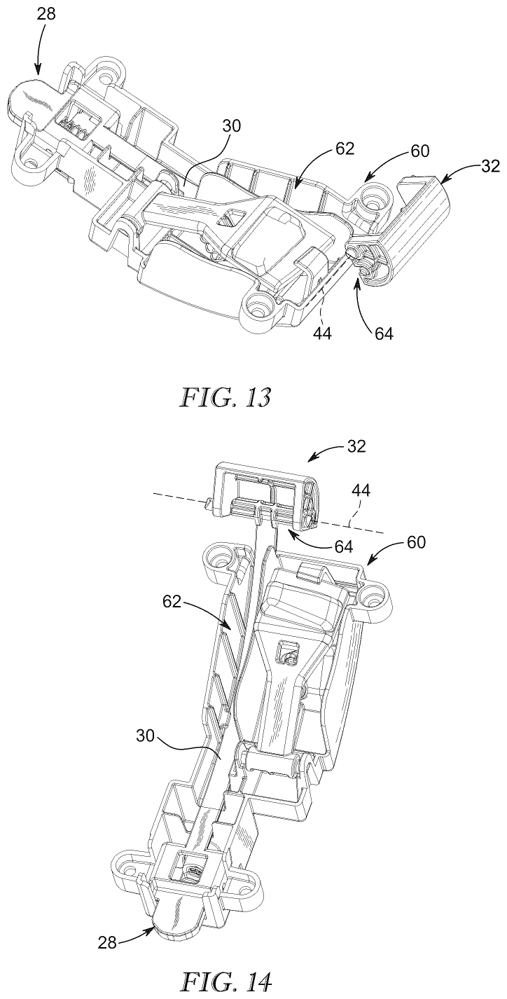

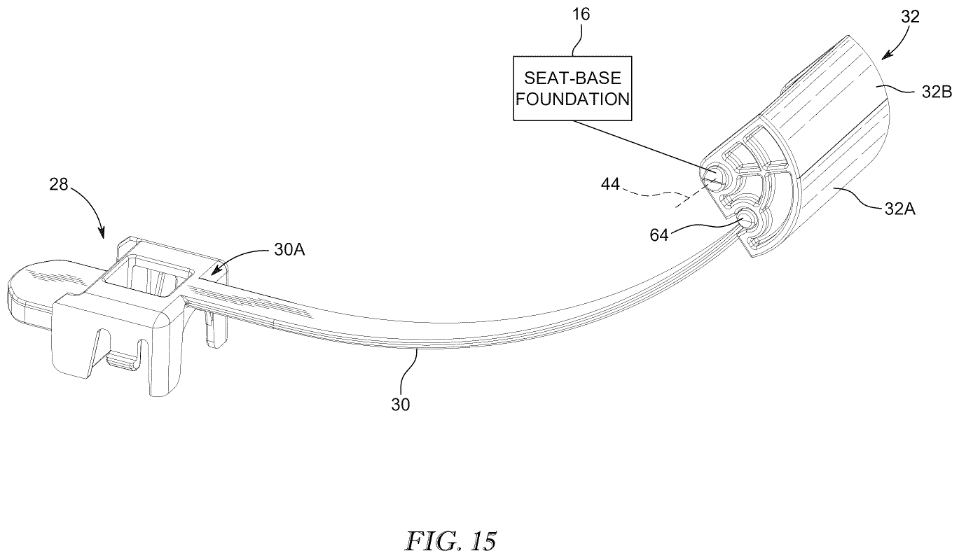

Each orientation indicator 22 further includes a strip guide 60 fixed to the seat-base foundation 16 and formed to include a guide passage 62 as shown in FIGS. 12-14. The actuator arm 30 is positioned within the guide passage 62. The strip guide 60 is configured to guide movement of the actuator arm 30 through the guide passage 62 as each movable protrusion 28 extends and retracts to and from the post-receiving space 42. The guide passage 62 is configured to impart deformation on the actuator arm 30 so that a first end 30A of the actuator arm 30 coupled to the corresponding movable protrusion 28 travels in a first direction and a second end 30B of the actuator arm 30 coupled to the indicator plate 32 travels in a second direction different than the first direction. The second end 30B of the actuator arm 30 includes an axle 64 mounted to the indicator plate 30 and spaced apart from the pivot axis 44. The axle 64 pivots relative to the indicator plate 32 as the movable protrusion 28 is actuated by the protrusion actuator 40.

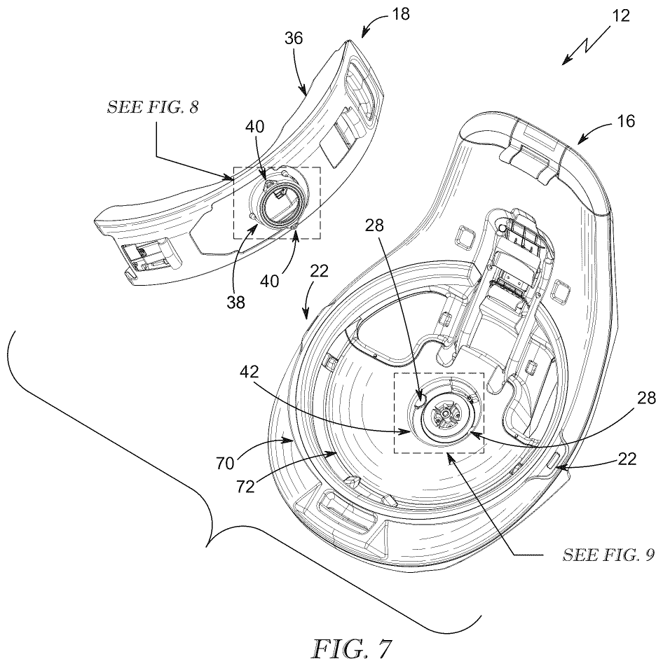

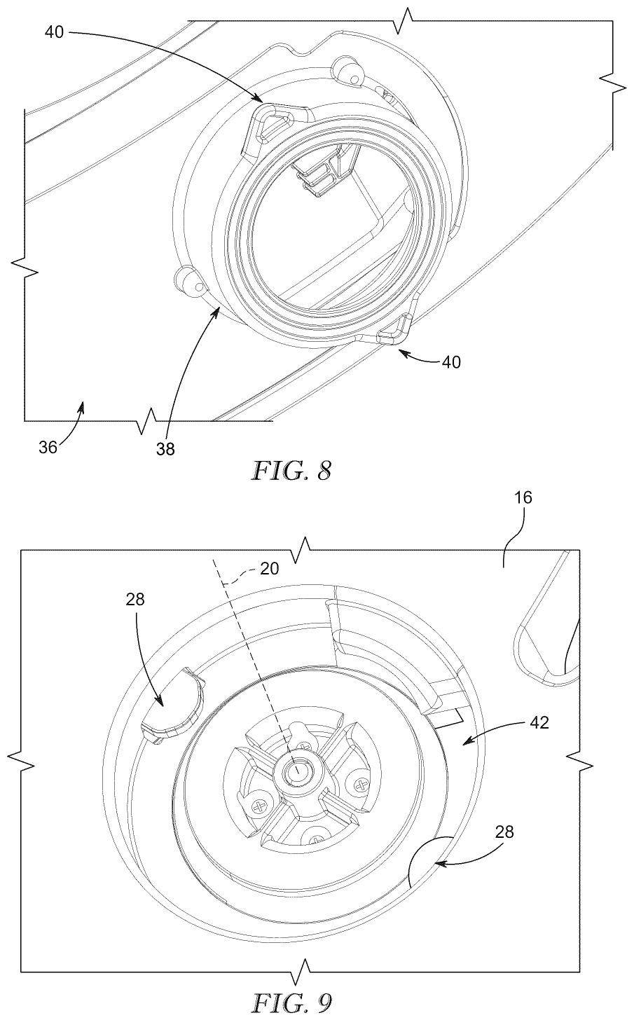

The seat-base foundation 16 includes an upper rim 70 and a peripheral bowl 72 extending between the upper rim 70 and the post-receiving space 42 as shown in FIG. 7. Each of the orientation indicators 22 is configured to display the first appearance and the second appearance at a location that is radially outward from the upper rim 70 from the vertical rotation axis 20. Each of the movable protrusions 28 is located below the upper rim 70 relative to the vertical rotation axis 20. The actuator arm 30 is flexible to extend along a curvature from the movable protrusions 28 to the location radially outward from the upper rim 70 and above the movable protrusions 28. In this way, the actuator arm 30 uses its flexibility to transfer motion of the movable protrusions in the first direction into motion of the second end 30B of the actuator arm 30 in the second direction to cause pivotable movement of the indicator plate 32 at the location radially outward from the upper rim 70 and above the movable protrusions 28.

In the illustrative embodiment, the indicator plates 32 display a first icon through the window 44 when the juvenile seat 14 is in the forward-facing orientation or the rearward-facing orientation and the indicator plates 32 display a different icon when the juvenile seat 14 is not in the forward-facing orientation or the rearward-facing orientation. In some embodiments, a different appearance may be displayed, such as a color, text, a combination of icon, color, and/or text, or any other suitable appearance.

1. A child restraint comprising
a seat base including a seat-base foundation adapted to rest on a vehicle seat and a seat-orientation controller coupled to the seat-base foundation for rotation about a vertical rotation axis,
a juvenile seat configured to couple to the seat-orientation controller to be secured to the vehicle seat, the juvenile seat being rotatable relative to the seat-base foundation with the seat-orientation controller between a forward-facing orientation and a rearward-facing orientation relative to the seat-base foundation, and
an orientation indicator configured to change between a first appearance in which the orientation indicator indicates that the juvenile seat is in the forward-facing orientation or the rearward-facing orientation, and a second appearance in which the orientation indicator indicates that the juvenile seat is not in the forward-facing orientation or the rearward-facing orientation,
wherein the orientation indicator includes a pair of retractable protrusions and the seat-orientation controller includes a pair of fixed cams,
wherein, when the juvenile seat is in the forward-facing orientation and the rearward-facing orientation, each cam engages a corresponding one of the pair of retractable protrusions to displace the pair of retractable protrusions so that the orientation indicator displays the first appearance, and
wherein, when the juvenile seat is not in the forward-facing orientation and the rearward-facing orientation, each cam is spaced apart from the pair of retractable protrusions and the orientation indicator displays the second appearance.

2. The child restraint of claim 1, wherein each orientation indicator further includes an indicator plate coupled to the seat-base foundation and configured to display the first appearance and the second appearance and an actuator arm coupled to one of the retractable protrusions for movement therewith and to the indicator plate to transfer movement of a corresponding retractable protrusion to the indicator plate to change the orientation indicator between the first appearance and the second appearance.

3. The child restraint of claim 2, wherein the indicator plate is coupled to the seat-base foundation for pivotable movement about a plate axis between a first position, in which a first portion of the indicator plate is visible through an opening formed in the seat-base foundation to display the first appearance, and a second position in which a second portion of the indicator plate is visible through the opening formed in the seat-base foundation to display the second appearance.

4. The child restraint of claim 3, wherein the actuator arm includes a flexible strip configured to translate lateral movement of each corresponding retractable protrusion into the pivotable movement of each corresponding indicator plate about the plate pivot axis.

5. The child restraint of claim 4, wherein each orientation indicator further includes a strip guide fixed to the seat-base foundation and formed to include a guide passage, the actuator arm is positioned within the guide passage and the strip guide configured to guide movement of the actuator arm through the guide passage as each retractable protrusion extends and retracts.

6. The child restraint of claim 5, wherein the guide passage is configured to impart deformation on the actuator arm so that a first end of the actuator arm coupled to the corresponding retractable protrusion travels in a first direction and a second end of the actuator arm coupled to the indicator plate travels in a second direction different than the first direction.

7. The child restraint of claim 1, wherein the seat-base foundation is formed to include a post-receiving space and each of the retractable protrusions extend into the post-receiving space when the juvenile seat is not in the forward-facing orientation and the rear-ward facing orientation, and the seat-orientation controller includes a seat mount configured to couple to the juvenile seat and an attachment post coupled to a lower end of the seat mount and arranged to extend into the post-receiving space formed in seat-base foundation to engage each of the retractable protrusions when the juvenile seat is in the forward-facing orientation and the rear-ward facing orientation.

8. The child restraint of claim 7, wherein the seat-base foundation includes an upper rim and a peripheral bowl extending between the upper rim and the post-receiving space, and each of the orientation indicators is configured to display the first appearance and the second appearance at a location that is radially outward from the upper rim.

9. The child restraint of claim 8, wherein each orientation indicator further includes an indicator plate coupled to the seat-base foundation and configured to display the first appearance and the second appearance through a corresponding window formed in the seat-base foundation at the location radially outward from the upper rim.

10. The child restraint of claim 9, wherein each orientation indicator further includes an actuator arm coupled to one of the retractable protrusions for movement therewith and to the indicator plate to transfer movement of a corresponding retractable protrusion to the indicator plate to change the orientation indicator between the first appearance and the second appearance, and wherein the actuator arm includes a flexible strip that is curved to travel from each corresponding retractable protrusion extending into the attachment post cavity toward the upper rim.

11. The child restraint of claim 9, wherein the indicator plate is mounted to the seat-base foundation for pivotable movement about a plate axis between a first position in which a first portion of the plate displays the first appearance through the window, and a second position, in which a second portion of the indicator plate displays the second appearance through the window.

12. The child restraint of claim 11, wherein the indicator plates display a first icon through the window when the juvenile seat is in the forward-facing orientation or the rearward-facing orientation and the indicators display a different icon when the juvenile seat is not in the forward-facing orientation or the rearward-facing orientation.

13. The child restraint of claim 1, wherein the pair of retractable protrusions are biased to normally display the second appearance.

14. A child restraint comprising:
a seat base,
a juvenile seat rotatable relative to at least a portion of the seat base about a vertical rotation axis between a forward-facing orientation and a rearward-facing orientation, and
an orientation indicator configured to change between a first configuration in which the orientation indicator indicates that the juvenile seat is in the forward-facing orientation or the rearward-facing orientation, and a second configuration in which the orientation indicator indicates that the juvenile seat is not in the forward-facing orientation or the rearward-facing orientation,
wherein the orientation indicator includes an actuator and the seat base includes an actuator mover,
wherein, when the juvenile seat is in the forward-facing orientation and the rearward-facing orientation, the actuator mover engages the actuator to cause the orientation indicator to assume the first configuration and indicate that the juvenile seat is in the forward-facing orientation or the rearward-facing orientation, and
wherein, when the juvenile seat is not in the forward-facing orientation and the rearward-facing orientation, the actuator mover is spaced apart from the actuator to cause the orientation indicator to assume the second configuration and indicate that the juvenile seat is not in the forward-facing orientation or the rearward-facing orientation.

15. The child restraint of claim 14, wherein the orientation indicator further includes an indicator plate coupled to the seat base and configured to display a first appearance and a second appearance and the actuator includes (i) a retractable protrusion configured to engage with the actuator mover and (ii) an actuator arm for movement with the retractable protrusion and coupled to the indicator plate to transfer movement of the retractable protrusion to the indicator plate to change the orientation indicator between the first appearance and the second appearance.

16. The child restraint of claim 15, wherein the indicator plate is coupled to the seat base for pivotable movement about a plate axis between a first position, in which a first portion of the indicator plate is visible through an opening formed in the seat-base foundation to display the first appearance, and a second position in which a second portion of the indicator plate is visible through the opening formed in the seat-base foundation to display the second appearance.

17. The child restraint of claim 16, wherein the actuator arm includes a flexible strip configured to translate lateral movement of each corresponding retractable protrusion into the pivotable movement of each corresponding indicator plate about the plate pivot axis, and wherein the orientation indicator further includes a strip guide fixed to the seat base and formed to include a guide passage, the actuator arm is positioned within the guide passage and the strip guide configured to guide non-linear movement of the actuator arm through the guide passage as the retractable protrusion extends and retracts.

18. The child restraint of claim 14, wherein the seat base includes a seat-base foundation formed to include a post-receiving space and a portion of the actuator extends into the post-receiving space when the juvenile seat is not in the forward-facing orientation and the rear-ward facing orientation, and wherein the seat base further includes a seat-orientation controller having a seat mount configured to couple to the juvenile seat and an attachment post coupled to a lower end of the seat mount and arranged to extend into the post-receiving space formed in seat-base foundation to engage the portion of the actuator when the juvenile seat is in the forward-facing orientation and the rear-ward facing orientation.

19. The child restraint of claim 18, wherein the seat-base foundation includes an upper rim and a peripheral bowl extending between the upper rim and the post-receiving space, and the orientation indicator is configured to display a first appearance and a second appearance at a location that is radially outward from the upper rim.

20. The child restraint of claim 19, wherein the orientation indicator further includes an indicator plate coupled to the seat-base foundation and configured to display the first appearance and the second appearance through a corresponding window formed in the seat-base foundation at the location radially outward from the upper rim, and wherein the actuator includes a flexible strip that is curved to travel away from the attachment post cavity toward the upper rim.
